(19) United States
(12) Patent Application Publication
(10) Pub. No.: US 2009/0031826 A1
(43) Pub. Date: Feb. 5, 2009

(54) High-Throughput Sample Preparation and Analysis for Differential Scanning Calorimetry

(75) Inventors: Pamela J. Stirn, Midland, MI (US); Andrew J. Pasztor, JR., Midland, MI (US); Mary Beth Seasholtz, Sanford, MI (US); Joseph A. Blazy, Midland, MI (US); Richard C. Winterton, Midland, MI (US); Paul L. Morabito, Midland, MI (US); David V. Dellar, Midland, MI (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: DOW GLOBAL TECHNOLOGIES INC., Midland, MI (US)

(21) Appl. No.: 12/181,094

(22) Filed: Jul. 28, 2008

Related U.S. Application Data
(60) Provisional application No. 60/952,883, filed on Jul. 31, 2007.

(51) Int. Cl. G01N 1/28; G01G 9/00

(52) U.S. Cl. 73/863.01; 73/863.11; 73/865

(57) ABSTRACT

A high throughput workstation includes: a sample deposition and annealing robot, a pan/sample weighing robot, and a thermal analyzer equipped with autosampler and data analysis system. After deposition, the solvent can be removed and multiple samples annealed simultaneously in a controlled manner. The sample pans are weighed before and after the samples are prepared using a robotic weigher. The high throughput workstation facilitates analysis of thermal properties of samples obtained via parallel plate reaction (PPR) in substantially less time than corresponding manual techniques.

### CROSS-REFERENCE TO RELATED APPLICATIONS

This application claims priority to U.S. Provisional Patent Application No. 60/952,883, filed Jul. 31, 2007, which is incorporated herein by reference.

### FIELD OF THE INVENTION

The invention relates to systems and methods that facilitate high throughput for the preparation and analysis of chemical samples, particularly for use with thermal characterization methods such as differential scanning calorimetry and thermogravimetric analysis.

### BACKGROUND OF THE INVENTION

In recent years, chemical discovery has seen an explosion of new science, such as genomics, proteomic and bioinformatics, as well as high-throughput technologies for identifying and/or creating new compounds or chemical entities, such as combinational chemistry. Such technologies allow the researcher to rapidly synthesize and/or identify large numbers of compounds.

Conducting large numbers of experiments results in the need to inspect or otherwise analyze hundreds or thousands of samples, e.g., for the presence of the desired result. And, a large number of the pre-selected samples require continuing analysis. The resulting voluminous data must then be processed effectively and efficiently, e.g., within a reasonable amount of time.

What is needed in the art are apparatus and methods for high-throughput multiple parallel synthesis, followed by high-throughput screening and characterization of individual components in arrays or combinatorial libraries. In addition, these techniques should preferably be easily adapted to microscale techniques. Further, these techniques and apparatuses should be adaptable not only to areas where combinatorial chemistry is commonly used, such as pharmaceutical, biotechnology, and agrochemical research, but also to a broad range of disciplines, including catalysis and polymer chemistry.

However, the inventors have found a lack of devices suitable for the high-throughput thermoanalysis of an array of samples or combinatorial libraries. Prior technology does not satisfy all the needs for high throughput analysis. Even when samples are synthesized using high-throughput methods, analysis typically uses manual methods that require separately preparing, annealing, and measuring the properties of each individual sample.

### SUMMARY OF THE INVENTION

In a first aspect, the invention provides a system comprising, a sample deposition system for automatically depositing samples into individual containers arranged on a first support in a predetermined arrangement; a balance for individually weighing the containers; a transfer system for individually transferring the containers between the support and the balance so as to maintain the predetermined arrangement; and a sample analysis system for analyzing the samples in the containers.

In a second aspect, the invention provides a system for handling and weighing containers arranged in a predetermined arrangement on a first support comprising, a balance for individually weighing the containers; and a robot comprising a movable gripper for individually transferring the containers between the first support and the balance so as to maintain the predetermined arrangement.

In a third aspect, the invention provides a method for the analysis of multiple samples comprising the steps of individually measuring the mass of a plurality of containers, wherein the containers are arranged in a first support in a first predetermined arrangement; depositing a sample to be analyzed into each container; individually measuring the mass of each container after a sample has been placed into the container; and measuring at least one physical property for each sample with a sample analysis system, wherein the mass of each container is determined using a system comprising, a balance for individually weighing the containers; and a robot comprising a movable gripper for individually transferring the containers between the first support and the balance so as to maintain the first predetermined arrangement.

In a fourth aspect, the invention provides a system for sealing a lid onto a container comprising a container—lid assembly; a crimping station comprising means for holding the container—lid assembly in place during sealing; a first die which rolls the container edge around the lid; a second die which cold welds the rolled edge; and a translation stage for transferring the container—lid assembly into the crimping station.

The systems and methods of the invention enable the simultaneous annealing of multiple compounds without cross-contamination or destruction of the analytical equipment. Further, the systems and methods of the invention substantially increase the number of thermoanalyses, particularly differential scanning calorimetry (DSC) and thermal gravimetric analysis (TGA), which may be completed per day.

### BRIEF DESCRIPTION OF THE DRAWINGS

FIG. 1 is a diagram of an exemplary embodiment of the system of the invention which illustrates a work flow of the methods of the invention.

FIG. 2 is a diagram of a second exemplary embodiment of the system of the invention containing separate a sample deposition system, and which illustrates the work flow of the methods of the invention.

FIG. 3 is a diagram of a third exemplary embodiment of the system of the invention containing separate robots containing a sample deposition system and a weighing system, and which illustrates the work flow of the methods of the invention.

FIG. 4 is a diagram of a fourth exemplary embodiment of the system of the invention containing separate robots containing a sample deposition system and a weighing and sealing system, and which illustrates the work flow of the methods of the invention.

FIG. 5 is a diagram of a fifth exemplary embodiment of the system of the invention containing a single robot containing a sample deposition system, a weighing, and a sealing system, and which illustrates the work flow of the methods of the invention.

FIG. 6 is a schematic view of an exemplary embodiment of the sample deposition system of the invention.

FIG. 7 includes a top and side view of an exemplary first support.

FIG. 8 is a schematic view of an exemplary embodiment of the weighing system of the invention.

FIG. 9 is a schematic view of an exemplary gripper for use in the weighing system of the invention.

FIG. 10 is a plan view of an exemplary stand for holding multiple first supports.

FIG. 11 is a schematic view of an exemplary embodiment of the sample weighing and sealing system of the invention.

FIG. 12 is a schematic view of an exemplary embodiment of the sample preparation, weighing, and sealing system of the invention.

FIG. 13 is a flow chart of an exemplary method without sealing the sample container.

FIG. 14 is a flow chart of an exemplary method with sealing the sample container.

### DETAILED DESCRIPTION OF THE INVENTION

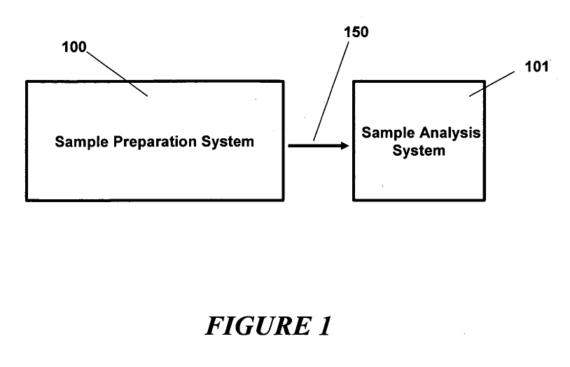

In a broad sense, as illustrated by FIG. 1, the invention provides a system comprising a sample preparation system (100) for the preparation of a plurality of samples and a sample analysis system (101) for the analysis of at least one physical property of each of the plurality of samples. After preparation of the samples is complete, the samples are transferred (150) to the sample analysis system.

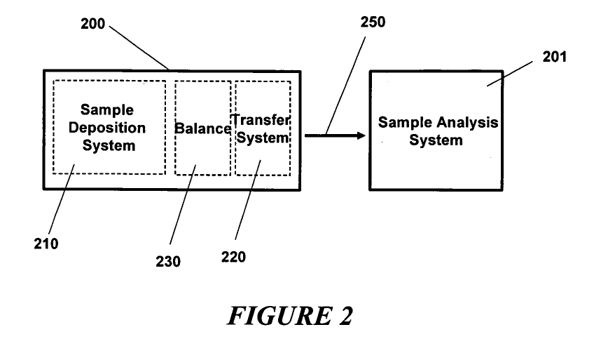

In a preferred embodiment, as displayed in FIG. 2, the invention provides the system comprising a sample preparation system (200) and a sample analysis system (201) for the analysis of at least one physical property of each sample. The sample preparation system (200) comprises a sample deposition system (210) for automatically depositing samples into individual containers arranged on a first support in a first predetermined arrangement, a balance (230), and a transfer system (220) for individually transferring the containers between the first support and the balance so as to maintain the first predetermined arrangement. After preparation of the samples is complete, the samples are transferred (250) to the sample analysis system.

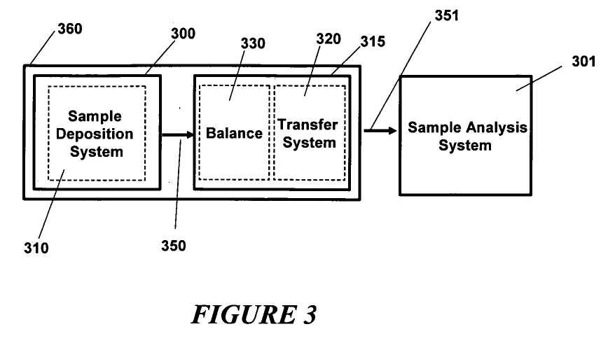

In a more preferred embodiment, as displayed in FIG. 3, the invention provides the system comprising a sample preparation system (360) comprising a first robot (300) comprising a sample deposition system (310) for automatically depositing samples into individual containers arranged on a first support in a first predetermined arrangement, a second robot (315) comprising a balance (330) and a transfer system (320) for individually transferring the containers between the first support and the balance so as to maintain the first predetermined arrangement, and a sample analysis system (301) for the analysis of at least one physical property of each sample. After samples are deposited into the individual containers, they are transferred (350) to the second robot. Finally, after preparation of the samples is complete, the samples are transferred (351) to the sample analysis system.

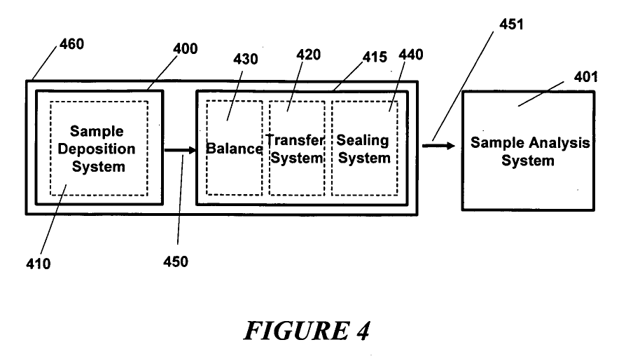

In a more preferred embodiment, as displayed in FIG. 4, the invention provides the system comprising a sample preparation system (460) comprising a first robot (400) comprising a sample deposition system (410) for automatically depositing samples into individual containers arranged on a first support in a first predetermined arrangement, a second robot (415) comprising a balance (430), a sealing system for placing lids on the individual containers (440) and a transfer system (420) for individually transferring the containers between the first support and the balance so as to maintain the first predetermined arrangement, and a sample analysis system (401) for the analysis of at least one physical property of each sample. After samples are deposited into the individual containers, they are transferred (450) to the second robot. Finally, after preparation of the samples is complete, the samples are transferred (451) to the sample analysis system.

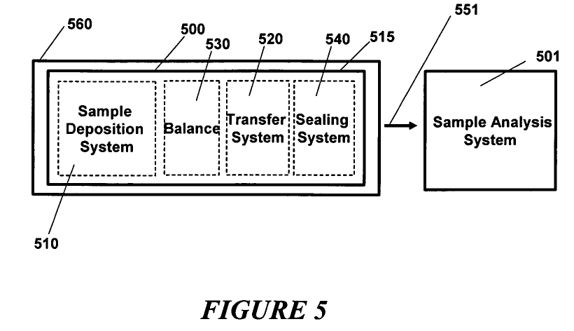

In a more preferred embodiment, as displayed in FIG. 5, the invention provides the system comprising a sample preparation system (560) comprising a single robot (500) comprising a sample deposition system (510) for automatically depositing samples into individual containers arranged on a first support in a first predetermined arrangement, a balance (530), a sealing system for placing lids on the individual containers (540) and a transfer system (520) for individually transferring the containers between the first support, the balance, and the sealing system so as to maintain the first predetermined arrangement, and a sample analysis system (501) for the analysis of at least one physical property of each sample. After preparation of the samples is complete, the samples are transferred (551) to the sample analysis system.

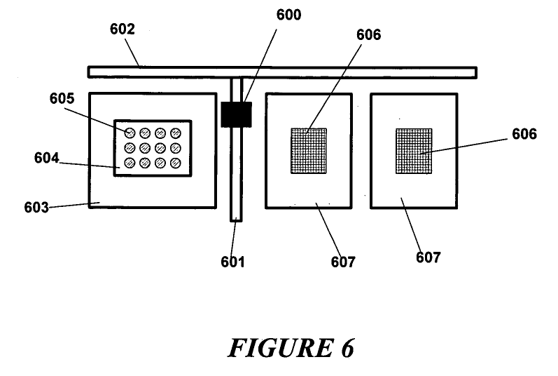

FIG. 6 illustrates a preferred embodiment of the sample deposition system of the invention, comprising an end-effector (600) connected to a movable arm (601) which moves along a track (602); and one or more first supports (606) each holding a plurality of containers in a first predetermined arrangement. For operation of the system, plurality of samples (604) may be provided which may be accessed individually (605).

If the sample is a solid, then the end-effector can be, for example, grippers (e.g., forceps, tongs, tweezers, or pincers), scoops (e.g., spoons), spatulas, and/or spears (e.g., forks). Each of the preceding preferably is made from a metal or plastic which is compatible with the samples being moved, for example, stainless steel, aluminum, titanium, or poly(tetrafluoroethylene).

If the sample is a liquid, then the end-effector can be, for example, a syringe, needles, cannulas, pipettes, or the like for placing a liquid (neat, solution, or suspension) sample into the containers. The sample deposition system can be automated, e.g. an automatic pipetter, and may be heated or cooled depending on the sample being moved to prevent boiling, freezing, crystallization, and/or precipitation of the sample.

The sample deposition system operates by the end-effector (600) withdrawing a sample (605) from a plurality of samples (604) and depositing the sample into one of the containers arranged on the first support (606) in the first predetermined arrangement. During deposition, the plurality of samples (604) may be optionally heated by a heater (603). The process of depositing a sample into each container is not limited to a single event. For example, the process of placing a sample into a container can include multiple events until a predetermined amount of the sample has been placed into the container. The process of depositing multiple samples into individual containers may further include one or more steps to clean or replace the element performing the deposition task to prevent cross-contamination of the individual samples between depositions of samples. For example, in depositing polymer samples which are dissolved in solution, a pipette may be used; the pipette may either be cleaned with an appropriate solvent before each sample deposition or the pipette may be replaced with a clean pipette for each deposition.

Each first support (606) may be heated by a heater (607). The heater provides the system the ability to maintain a predetermined thermal history for the samples, such as, but not limited to, heating, cooling, annealing, and any combination thereof. The heater can utilize resistive, microwave, infrared (radiant), and/or ultrasound effects to heat the samples. Preferably, the heater comprises a resistive heating element. The sample holder may be placed either on top of the resistive heating element and heated from below, or the sample holder may be surrounded by resistive heating elements, and heated from all sides. Alternatively, the sample holder may be placed below a resistive heating element and heated from above. The resistive heating element may comprise a material which radiates heat when an electric current is applied across the material; the temperature is controlled by control of the current by those means known in the art. Current is often controlled by changing the voltage placed across the material using, for example, a variable transformer. Such materials include ceramics, certain metals (e.g., platinum, copper, aluminum) and/or metal alloys (Nichrome, a Ni—Cr alloy). The voltage can be controlled manually or by an external device. The external device controlling the voltage can also control the heating time as well. The time the temperature is maintained can be controlled manually or by a timer. The external device may further allow for changing the heating temperature in a controlled manner to provide heating and/or cooling ramps for the samples (e.g., a predetermined thermal history). Each of the preceding heaters and controlling elements (i.e., timers, variable transformers, etc.) may be automated, (i.e., the operation of temperature change and timing may be an unattended process).

Optionally, the system comprises means for providing and/or maintaining an inert atmosphere over the samples. Such means include where part of, or the entire system of, the invention is within a drybox. Alternatively, an enclosure can be placed about only the portion of the system containing the samples. Examples include a bag or box with at least one inlet and/or at least one outlet which are purged with an inert gas, or mixture of inert gases, to maintain an inert atmosphere. The inlet(s) and/or outlet(s) can be at a single location or multiple locations about the box. Preferably, the box and bag comprise an optically transparent material, e.g., glass or plastic, such as, but not limited to, polyethylene (PE), polycarbonate (PC), or poly(methyl methacrylate) (PMMA).

Inert atmospheres are those which will not cause degradation or reaction of the sample. Such atmospheres may contain limited levels of oxygen and/or water, however, the acceptable level of water and/or oxygen will depend on the samples being analyzed, and is readily apparent to one skilled in the art. Such atmospheres preferably include gases such as, but are not limited to, nitrogen, helium, and argon, and mixtures thereof. The bag or box preferably has a sealable or resealable opening through which samples may be filled and/or passed (e.g., a lid).

The first support of the invention functions to keep multiple samples physically separated, such that each sample is contained within its own container, while maintaining the containers in a first predetermined arrangement. The first predetermined arrangement could be, for example, a rectangular or circular array. However, other arrangements could be also be used.

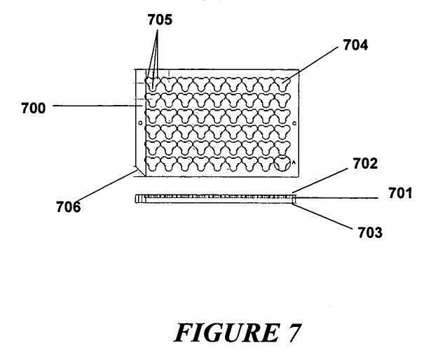

A preferred embodiment of the first support is shown in FIG. 7. In the exemplary embodiment, the first support comprises a block (700) with recesses (704) for accepting a plurality of containers. The block and containers may be prepared from a material that can withstand the sample processing conditions without failure and without contaminating the samples or reacting with the samples. The block has a top surface (702) and bottom surface (703), at least one of which is capable of being adapted to hold the containers, for example, a flat face of a plate or disk. The block itself may be rectangular, circular, or an irregular structure provided it has at least one surface capable of being adapted to hold the containers. The recesses in the block, preferably, allow for automated removal and insertion of the containers. For example, a recess may be shaped to receive a gripper that can grip a container from above while the container is in the recess (e.g., for inserting the container into the recess or removing the container from the recess).

A block (700) may be fabricated from materials such as metal, metal alloys, glass, or plastic. Preferred metals include titanium or aluminum; preferred metal alloys include, but are not limed to, stainless steel. If the block comprising the first support is made from an appropriate material, then the block can also serve as the resistive heating element, as discussed previously.

Each sample to be analyzed is placed in one or more of the containers that have been arranged in a first predetermined arrangement on the first support. The containers are preferably prepared from materials such as metal, glass, or an unreactive polymer such as poly(tetrafluoroethylene). Preferred metals include copper, aluminum, titanium, platinum, and/or silver. The containers typically are in the shape of bowls or pans and may further include an optional lid which may be attached after the sample is placed in the container. Preferably, the lid comprises the same material composition as the container. The containers, preferably, hold a volume of about 1 μL to about 1000 μL. More preferably, the containers can hold a volume of about 10 μL to about 100 μL. Even more preferably, the containers can hold a volume of about 25 μL to about 90 μL.

The recesses (704) in the block (700) are preferably of the same general shape as the bottom of the containers, optionally, with additional space to allow an element of the transfer system to insert and remove each container. Preferably, the block has from about 2-512 recesses for accepting the containers. More preferably, the block has from about 4-128 recesses for accepting the containers. Even more preferably, the block has from about 16-64 recesses for accepting the containers. Even more preferably, the block has from about 32-64 recesses for accepting the containers.

In certain preferred embodiments of the invention, the block is made from silicon or aluminum and the containers are each made from copper, aluminum, titanium, platinum, and/or silver. More preferably, the block is made from aluminum and the containers are each made from copper, aluminum, titanium, platinum, and/or silver. Even more preferably, the block is made from aluminum and the containers are each made from aluminum, titanium, or platinum. Even more preferably, the block and the containers are each made from aluminum.

The support of the invention has several distinct advantages over alternative ways of performing parallel experiments. First, the use of individual containers, instead of using a plate, allows for individual handling of each container (or experiment). When arranged in an array, the support of the invention enables the containers to be re-arrayed to separate those that show desired properties from the rest, in order to perform further processing or analysis of a subset of the experiments. Also individual containers can be moved to alternative predetermined arrangements in alternative supports and/or holders, e.g., the first support holds the containers in a rectangular array whereas a second support (e.g. a holder for an autosampling DSC) is in a circular arrangement.

In the instant invention, the samples are preferably moved while in the containers. The transfer system for individually transferring the containers between the support and the balance so as to maintain the first predetermined arrangement preferably includes an element for grabbing and placing each of the containers, which itself is movable, or secured to a movable arm. In preferred embodiments, the transfer system is part of an automated system (robot). Such elements for grabbing and placing each of the containers include grippers (e.g., forceps, tongs, tweezers, or pincers), scoops (e.g., spoons), spatulas, and/or spears (e.g., forks). Each of the preceding, preferably, is made from a metal or plastic which is compatible with the samples and/or containers being moved. Preferred elements for grabbing and placing each of the containers include grippers (e.g., forceps, tongs, tweezers, or pincers), or spatulas. More preferred devices are grippers (e.g., forceps, tongs, tweezers, or pincers).

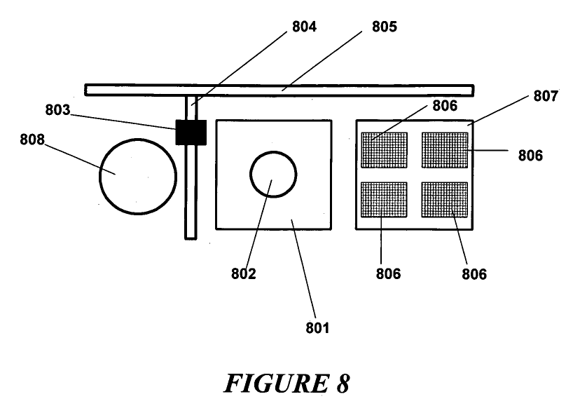

Referring to FIG. 8, in one embodiment of the invention, the second robot (i.e., the weighing system) comprises a balance (801) containing a weighing surface (802); and a transfer system comprising a end effector (e.g., a gripper) (803) connected to a movable arm (804) which moves along a track (805); first supports (806), each holding a plurality of containers in a first predetermined arrangement; a storage stand (807) for first supports (806); and a second support (808) for holding containers in a second predetermined arrangement in a sample analysis system.

The transfer system operates by the gripper (803) removing a container from the plurality of containers arranged on the first support (806) and placing the container onto the weighing surface (802) of the balance (801). The mass of the container is determined, then the gripper removes the container from the weighing surface of the balance and replaces the container on the first support so as to maintain the first predetermined arrangement.

The transfer system may perform additional tasks. For example, the transfer system may operate by the gripper (803) removing containers from the plurality of containers arranged on the first support (806) and placing the containers onto a second support (808) in a second predetermined arrangement. The second support (808) may hold the containers in the second predetermined arrangement in the sample analysis system.

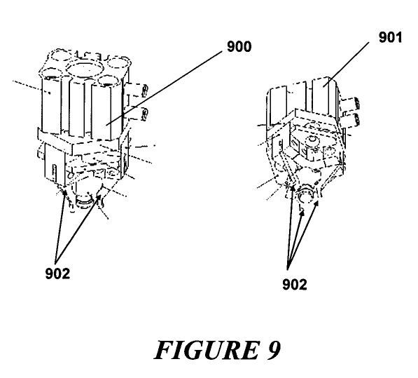

The grippers of the transfer system may have two or more gripping surfaces. Preferably, the grippers have two or three gripping surfaces. An exemplary gripper of the invention is shown in a side view (900) and bottom view (901) in FIG. 9, illustrating the three gripping surfaces (902).

The transfer system may also transfer the containers from the first support to the second support such that the containers are maintained in a second predetermined arrangement. In another preferred embodiment, after determining the mass of a container containing a sample, the transfer system may also transfer the container from the balance to the second support so as to maintain a second predetermined arrangement. Balances (or scales) are familiar to those of skill in the art for determining the mass of an object, and may be top-loading or bottom-loading. Preferably, the balance is capable of measuring masses in the range from about 1 μg to 100 g with readability of about ±1 μg to ±1.0 mg. More preferably, the balance has a readability of about ±10 μg to ±0.1 mg. The balance may operate by any means known to determine the mass of a compound; for example, but not limited to, counterbalancing a known mass (beam balances), springs, hydraulic or pneumatic forces, or through use of a strain gauge.

The balance may further comprise means for isolating the sample being measured from external perturbations. Typically, the balance has a weighing surface onto which the containers are placed for measurement. The balance may further comprise an enclosure over the entire balance or only the weighing surface to isolate the sample during measurements. Such an enclosure may also include a sliding or removable door to allow samples to be move in and out of the balance. Alternatively, the entire enclosure may be removable to allow containers to be moved onto and off the weighing surface. Additional means for isolating the balance from external perturbations include placing the balance on a table which is suspended by a cushion of a gas (typically, air or nitrogen; i.e., an ‘air table’) to isolate the balance from vibrations.

The transfer system is preferably capable of precisely controlling the force the gripping surfaces are exerting on the containers to prevent damaging the same. Forces applied by the gripping surfaces can be controlled by hydraulic or pneumatic pressures which are adjustable with internal valves (e.g., needle valves).

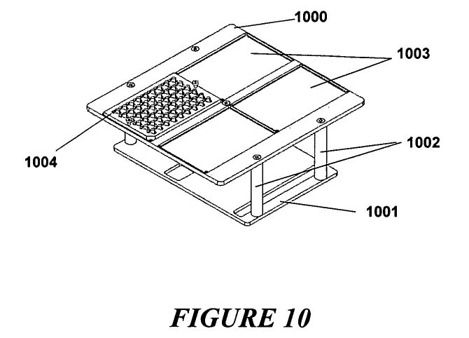

Multiple blocks may be mounted on a structure, such as a table or stand. The structure may hold multiple blocks on the same plane and/or in multiple planes such that they are stored either vertically or horizontally, or both. An example of a structure is shown than can hold four blocks (1004) in the same plane is shown in FIG. 10. A table (1000) is suspended above a bottom support (1001) by vertical legs (1002) to the blocks (1004).

In certain aspects, any one or more of the sample analysis system and/or the sample preparation system, including the sample deposition and the transfer systems, may further comprise at least one computer to control the functions of the same. Each computer may receive information including, but not limited to, sample identification, physical properties (e.g., mass, thermal properties, etc.), and thermal histories. Further, one or more of the computers may be connected to one another either directly or as part of a network to supply each of the acquired and/or supplied information to a common database.

Each of the elements of the invention may be part of a single or multiple robots. Multiple elements of the invention may also be part of the same robot. For example, in certain preferred embodiments, the sample deposition system and the heater are part of a single robot. In certain other preferred embodiments, a first robot comprises the sample deposition system, the heater, and means for maintaining an inert atmosphere over the samples. In certain other preferred embodiments, a second robot comprises the balance and the transfer system. In certain other more preferred embodiments, a first robot comprises the sample deposition system, the heater, and means for maintaining an inert atmosphere over the samples, and a second robot comprises the balance and the transfer system.

In other preferred embodiments, a single robot comprises the sample preparation system, i.e., the sample deposition system, the balance, and the transfer system.

In another preferred embodiment of the first aspect, the invention provides the system comprising, a plurality of containers; a first support adapted for holding the containers in a first predetermined arrangement, the first support having a top surface, a bottom surface, and a plurality of recesses in the top surface for receiving the containers; a robot comprising a sample deposition system for automatically depositing samples into individual containers arranged on the first support in the first predetermined arrangement, and a heater for heating the containers; a balance for individually weighing the containers; a transfer system for individually transferring the containers between the first support and the balance so as to maintain the first predetermined arrangement; and a differential scanning calorimeter for analyzing the samples in the containers.

In another preferred embodiment of the first aspect, the invention provides the system comprising, a plurality of containers; a first support adapted for holding the containers in a first predetermined arrangement, the first support having a top surface, a bottom surface, and a plurality of recesses in the top surface for receiving the containers; a first robot comprising a sample deposition system for automatically depositing samples into individual containers arranged on the first support in the first predetermined arrangement, a heater for heating the samples in the containers; and means for maintaining an inert atmosphere over the samples; a second robot comprising a balance for individually weighing the containers; a transfer system for individually transferring the containers between the first support and the balance so as to maintain the first predetermined arrangement; and a differential scanning calorimeter for analyzing the samples in the containers.

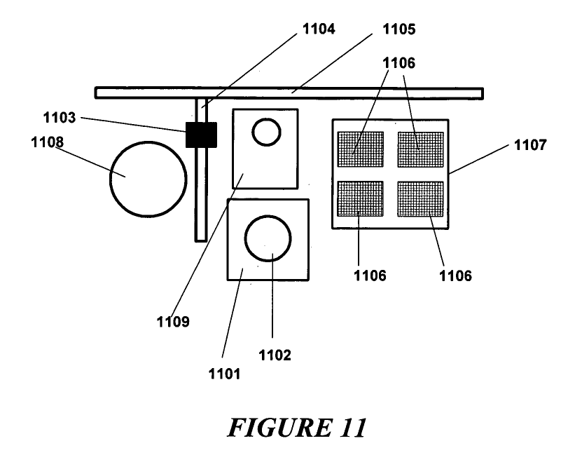

Referring to FIG. 11, in one embodiment of the invention, the second robot comprises a balance (1101) that includes a weighing surface (1102); a transfer system comprising an end-effector (1103), containing a gripper and a vacuum aspirator, connected to a movable arm (1104) which moves along a track (1105); a second support (1108) for holding containers in a second predetermined arrangement in a sample analysis system, and a sealing system (1109) for capping and crimping a lid on each container. The gripper and vacuum aspirator may be in separate end-effectors which are movable along the same movable arm (1104). Alternatively, the gripper and vacuum aspirators may be in separate end-effectors mounted to separate movable arms moving along the same track (1105).

For operation, first supports (1106) each holding a plurality of containers, each containing a sample to be analyzed, in a first predetermined arrangement (optionally stored on a storage stand (1107) and a plurality of container lids are provided. The robot operates by the gripper removing a container containing a sample from the plurality of containers arranged on the first support (1106) and placing the container onto the weighing surface (1102) of the balance (1101). The mass of the container is determined, then either (i) the specialized vacuum aspirator of the end-effector (1103) picks up a single lid and places it on the container to form a container-lid assembly, and then the gripper removes the assembly from the weighing surface and places it on the sealing system (1109); or (ii) the gripper moves the container back to the first support (1106) so as to maintain the first predetermined arrangement, then the specialized vacuum aspirator of the end-effector (1103) picks up a single lid and places it on the container to form a container-lid assembly. The gripper may then move the container-lid assembly from the first support to the sealing system (1109). Preferably, the lids have a diameter less than the diameter of the container such that when placed on the container, the lid fits inside the container.

The sealing system (1109) of the invention comprises a translation stage and a crimping station comprising two dies and means for holding the pan in place during sealing. The translation stage moves the container-lid assembly to the crimping station. The crimping station seals the container via a two-stage sealing process. The first die rolls around the edge of the container to provide a rolled pan edge; the second die cold welds rolled edge. Means for holding the container-lid assembly in place during the sealing process which may be used as are evident to one skilled in the art such that the means do not interfere with the required operations of the two dies. For example, the container-lid assembly may be held in a shallow depression of the same general shape of the bottom of the container on the surface of the crimping station.

Preferably, the means for holding the container is a vacuum provided at a vacuum port present in the surface of the crimping station. The vacuum port may be of any shape and size, provided that the container bottom completely covers the port. In some embodiments, the port comprises a single opening in the surface of the crimping station; in other embodiments, the port may comprise multiple openings in the surface of the crimping station, closely arrayed such that the container covers all the openings of the port. After sealing, the gripper moves the sealed container from the sealing system to the second support (1108) so as to maintain the second predetermined arrangement.

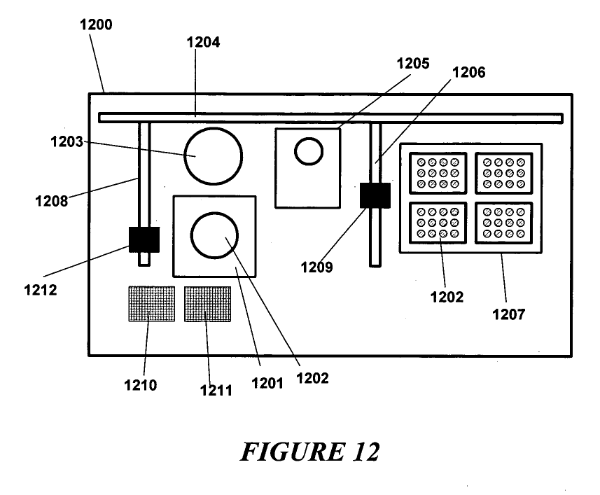

Referring to FIG. 12, in preferred embodiment of the invention, the sample preparation system contains a single robot comprising a sample deposition system, a transfer system, and a sealing system. The robot may be contained in a vented enclosure (1200) and comprises a balance (1201) containing a weighing surface (1202); a first end-effector (1212) containing a cannula and connected to a first movable arm (1206) which moves along a track (1204); a second end-effector (1209) containing a gripper and a vacuum aspirator and connected to a second movable arm (1208) which moves along a track (1204); a sealing station (1205) for capping and crimping a lid on each container, and a second support (1203) for holding the containers in a second predetermined arrangement in a sample analysis system. For operation, first supports (e.g., two first supports (1210) and (1211)) each capable of holding a plurality of containers in a first predetermined arrangement, a plurality of samples (1202) [optionally held in a source rack (1207)], and a plurality of lids for the containers are provided.

The robot operates by the gripper removing an empty container from the plurality of containers arranged on the first support (1210) and placing the container onto the weighing surface (1202) of the balance (1201). The mass of the container is determined, then the gripper removes the container from the weighing surface and places it onto either of the first supports (1210 or 1211) in the first predetermined arrangement. In one operation, the empty containers are removed from and replaced into the same first support (1210). In another operation, the empty containers are removed from one first support (1210) and, after weighing, placed into the second support (1211) while maintaining the first predetermined arrangement. One or both of the first supports may be heated during the weighing, deposition, and/or annealing steps.

Then, the cannula withdraws a sample from a plurality of samples (1202) and deposits the sample into an individual container arranged on the first support (1210 or 1211) in the first predetermined arrangement. Alternatively, the empty container can be filled while on the balance. During deposition, the plurality of samples (1202) may be optionally heated and/or stirred or shaken by the source rack (1207) if necessary. As discussed previously, the process of depositing a sample into each container is not limited to a single event (supra). The process of depositing multiple samples into individual containers may further include one or more steps to clean or replace the element performing the deposition task to prevent cross-contamination of the individual samples between depositions of samples. For example, in depositing polymer samples which are dissolved in solution, a pipette, syringe, or cannula may be used which may either (i) be cleaned with an appropriate solvent before each sample deposition; or (ii) replaced with a clean pipette, syringe, or cannula for each deposition. Optionally, the containers may be heated to remove any volatiles (e.g., solvents) and/or to anneal the samples in the container.

Next, the gripper removes a container from the plurality of containers arranged the first support (1210 or 1211) and places the container onto the weighing surface (1202) of the balance (1201). The mass of the container is determined, then either (i) the specialized vacuum aspirator of the first end-effector (1212) picks up a single lid and places it on the container to form a container-lid assembly, and then the gripper of the first end-effector (1212) removes the assembly from the weighing surface and places it on the sealing system (1205); or (ii) the gripper moves the container back to one or the other of the first supports (1210 or 1211) so as to maintain the first predetermined arrangement, then the specialized vacuum aspirator of the end-effector (1212) picks up a single lid and places it on the container to form a container-lid assembly. The gripper may then move the container-lid assembly from the first support to the sealing system (1205).

After sealing, the sealed containers are individually moved by the gripper to the weighing surface (1202) of the balance (1201). The mass of the container, sample, and lid is determined, then the gripper removes the sealed container from the weighing surface and places the container on either the first (1210 or 1211) or second support (1203) so as to maintain the first or second predetermined arrangement, respectively.

In another preferred embodiment of the first aspect, the invention provides the system comprising, a plurality of containers; a first support adapted for holding the containers in a first predetermined arrangement, the first support having a top surface, a bottom surface, and a plurality of recesses in the top surface for receiving the containers; a sample analysis system for analyzing the samples in the containers; a second support for holding the individual containers in a second predetermined arrangement in the sample analysis system; and a robot comprising a sample deposition system for automatically depositing samples into individual containers arranged on the first support in the first predetermined arrangement, a heater for heating the samples in the containers; means for maintaining an inert atmosphere over the samples; a balance for individually weighing the containers; a sealing system; and a transfer system for individually transferring the containers among the supports, balance, and sealing system.

The sample analysis system for analyzing the samples in the containers is preferably a thermoanalysis instrument. Preferred thermoanalysis include, but are not limited to, reaction calorimetry, parallel reaction calorimetry, thin-film calorimetry, parallel differential scanning calorimetry, differential thermal analysis (DTA), crystallization analysis fractionation (CRYSTAF) analysis, thermal fractionated crystallization (TFC), and thermogravimetric analysis (TGA). These techniques may be used alone, or in any combination. Preferably, the sample analysis system includes a means for handling and/or measuring more than one sample, either simultaneously or in series (i.e., ‘an autosampler’).

Preferably, the sample analysis system is a differential scanning calorimeter (DSC), i.e., an instrument utilizing a thermoanalytical technique in which the difference in the amount of heat required to increase the temperature of a sample being analyzed and a reference sample are measured as a function of temperature. Both the analysis sample and reference sample are maintained at very nearly the same temperature throughout the experiment. Generally, the temperature program for a DSC analysis is designed such that the sample holder temperature increases linearly as a function of time. The reference sample should have a well-defined heat capacity over the range of temperatures to be scanned. When the analysis sample undergoes a physical transformation such as a phase transition, chemical reaction, or decomposition, more (or less) heat will need to flow to it than the reference to maintain both the analysis and reference samples at the same temperature. Such phase transitions include, melting (solid-liquid), crystallization (liquid-solid), crystal phase changes (crystal-crystal), crystal-liquid crystal, liquid crystal-liquid crystal (e.g. nematic-smectic or smectic-smectic transitions), liquid crystal-liquid, sublimation (solid-gas), polymer phase transitions (e.g., glass transitions), and the like.

Whether more or less heat must flow to the sample depends on whether the physical transformation is exothermic or endothermic. For example, as a solid sample melts to a liquid it will require more heat flowing to the sample to increase its temperature at the same rate as the reference. This is due to the absorption of heat by the sample as it undergoes the endothermic phase transition from solid to liquid. Likewise, as the sample undergoes exothermic processes (such as crystallization) less heat is required to raise the sample temperature. By observing the difference in heat flow between the sample and reference, differential scanning calorimeters are able to measure the enthalpy of such transitions. This is typically done by integrating the peak corresponding to a given transition. The enthalpy of transition can be expressed using the equation, ΔH=KA, where ΔH is the enthalpy of the transition, K is the calorimetric constant, and A is the area under the curve. The calorimetric constant is dependent on the instrument, and can be readily determined by analyzing a reference sample with a known transition enthalpy. DSC may also be used to observe more subtle phase changes, such as glass transitions.

An alternative technique, which shares much in common with DSC, is differential thermal analysis (DTA). In this technique the heat flow to the sample and reference remains the same rather than the temperature. When the sample and reference are heated identically, phase changes and other thermal processes cause a difference in temperature between the sample and reference. Both DSC and DTA provide similar information; DSC is the more widely used of the two techniques.

The thermogravimetric analyzer (TGA) can be any instrument which measures the changes in the mass of a sample as a function of temperature. The sample mass is continuously measured as the temperature is raised. Often the sample is suspended by a bottom-loading balance, however, top-loading balance may also be utilized. TGA is commonly employed in research and testing to determine characteristics of materials such as polymers, to determine degradation temperatures, absorbed moisture content of materials, the level of inorganic and organic components in materials, decomposition points of explosives, and solvent residues. TGA is also often used to estimate the corrosion kinetics in high temperature oxidation and changes in mass related to chemical reactions (e.g. loss of a volatile side-product).

The preceding discussion of the various embodiments of the first aspect of the invention also relate to both the systems of the following second aspect of the invention and the method of the third aspect of the invention.

In a second aspect, the invention provides a system for handling and weighing containers arranged in a predetermined arrangement on a support comprising a balance for individually weighing the containers; and a robot comprising a movable gripper for individually transferring the containers between the first support and the balance so as to maintain the predetermined arrangement.

In a preferred embodiment of the second aspect, the invention provides the system further comprising a sealing system. Preferred embodiments thereof have been discussed previously in connection with FIGS. 6, 11, and 12 (supra).

In third aspect, the invention provides a method for the analysis of multiple samples comprising the steps of individually measuring the mass of a plurality of containers, wherein the containers are arranged in a first support adapted for holding the containers in a first predetermined arrangement; depositing a sample to be analyzed into each container; individually measuring the mass of each container after a sample has been placed into the container; and measuring at least one physical property for each sample with a sample analysis system, wherein the mass of each container is determined using a system comprising, a balance for individually weighing the containers; and a robot comprising a movable gripper for individually transferring the containers between the first support and the balance so as to maintain the first predetermined arrangement.

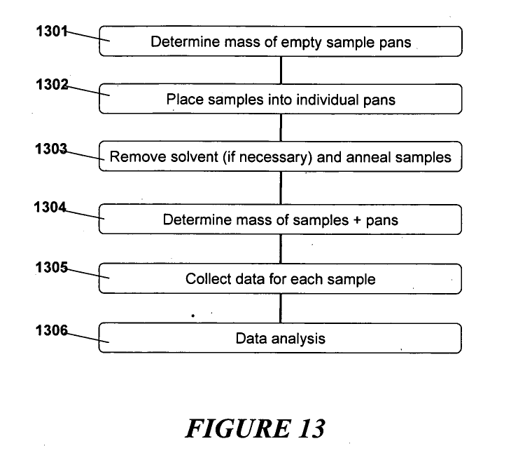

An exemplary embodiment of the method is illustrated by the flow chart of FIG. 13. Therein, a first step (1301) involves determining the mass of a plurality of containers arranged on a first support in a first predetermined arrangement, using the transfer system according the first aspect of the invention. In a second step (1302), samples to be analyzed are placed into each of the plurality of containers. Preferably, the samples are placed in the plurality of containers using a sample deposition system according to the first aspect of the invention, however, the samples may also be placed in the containers manually. In a third (and optional) step (1303), the samples may be simultaneously heated to remove solvent or otherwise annealed. Fourth (1304), the containers are again weighed to determine the mass of each using the transfer system according the first aspect of the invention. Finally, the containers are analyzed (1305), and the data analyzed (1306) to determine at least one physical property of the sample.

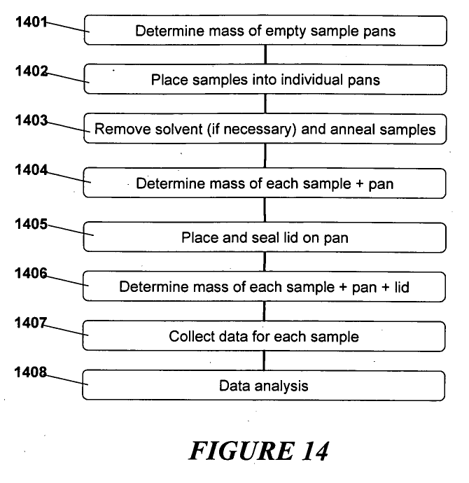

A preferred embodiment of the method of the third aspect is illustrated by the flow chart of FIG. 14. Therein, a first step (1401) involves determining the mass of a plurality of containers arranged on a first support in a first predetermined arrangement, using the transfer system according the first aspect of the invention. In a second step (1402), samples to be analyzed are placed into each of the plurality of containers. Preferably, the samples are placed in the plurality of containers using a sample deposition system according to the first aspect of the invention, however, the samples may also be placed in the containers manually. In a third (and optional ) step (1403), the samples may be simultaneously heated to remove solvent or otherwise annealed. Fourth (1404), the containers are again weighed to determine the mass of each using the transfer system according the first aspect of the invention. The transfer system then moves the containers to the sealing system where a lid is placed and sealed on the container (1405), and the sealed container is weighed a final time (1406) before the containers are analyzed (1407), and the obtained data analyzed (1408) to determine at least one physical property of the sample.

### DEFINITIONS

The term “plurality” as used herein means more than one.

The term “robot” as used herein means a device capable of being programmed to perform a designated task in a controlled manner.

The term “sample” as used herein means a composition which contains at least one material for which a property is being measured according the invention. The sample may contain materials such as polymers, pharmaceuticals, liquid crystals, solvents, excipients, and/or diluents. Samples may comprise one or more materials with a known or unknown property, e.g., if the property is known the sample may be a reference sample.

The term “drybox” as used herein means a system comprising a substantially air-tight box in which an inert atmosphere is maintained through maintaining a positive pressure of inert gas within the box with respect to outside the box, and optionally a means for circulating the atmosphere within the box though purifiers which remove oxygen and/or water from the atmosphere. Typically, a blower or a fan is used to circulate the atmosphere through the purifiers. The purifiers are often filled with copper-containing catalysts for removing oxygen from the atmosphere and activated molecular sieves for removing water from the atmosphere.

### EXAMPLES

FIG. 1 illustrates the general workflow described by the invention and exemplified by the following examples. The principle hardware components used in the workstation and methods of the invention are noted in Table 1.

TABLE 1

| Item | Vendor |
|---|---|
| EVO750 Robot | Tecan AG, Männedorf. Switzerland |
| Mettler Toledo 285/01 SAG | Mettler-Toledo Corporation, |
| five-place | Columbus, |
| Balance | OH |
| AlphaStep Closed Loop Step | Oriental Motor USA Corporation, |
| Motor and Driver with Integrated | Torrance, CA |
| Controller Communication Cable - | |
| P/N AS46AAP-N10 with FC04W5 | |
| Communication Cable | |
| Three-finger Gripper Assembly | ABD - Beaverton, MI |
| Swinging Balance door | ABD - Beaverton, MI |
| Static dissipater | Mettler Antistatic |
| | PRU-27-18-27 200. This part is |
| | available as a Mettler-Toledo U |
| | ionizer (VWR #11238-356). This |
| | device is an OEM part manufactured |
| | by HAUG North America LTD., |
| | Mississauga, ON, Canada |
| Titer Plate Rack | ABD-Beaverton, MI |

### Example 1

### High Throughput-DSC Workflow

### Example 1a

### Sample Synthesis

PPR (Parallel Plate Reaction) synthesis experiments provided libraries of polymers (each 48 Wells (8×6)) for DSC analysis, and occurred outside the DSC workflow. A database LibraryID (LibID) was associated with each set of samples for tracking through subsequent analysis. The yield of each polymer in each library and the amount available was determined for use in further experiments and was used as input for the deposit-anneal unit operation (infra).

### Example 1b

### Tare Empty Pans

DSC pans were arranged on a block consisting of a 9×6 array of sample “wells” 8 rows are for samples. The 9th row is reserved for the addition of standards and blanks. Empty DSC pans were manually loaded into an empty (9×6) block. Each titer-plate has a unique barcode, enabling tracking the physical plate through the unit operations. Up to four titer-plates of empty pans can be tared on the weigh robot unit. Once tared, they may be stored for later use.

### Example 1c

### Solution Preparation

The polymer material from the synthesis (Example 1a) was usually in powder form, and must be dissolved or suspended at the proper concentration for use in the deposit-anneal unit-operation. The solution prep was typically accomplished using a robot, the deposit-anneal robot and the proper procedure, or manually. Solutions of standards may also be prepared.

### Example 1d

### Robotic Weighing Apparatus

The titer-plates to be tared (from Example 1b) were placed on the weigh robot's deck, and the weigh robot software started. The pans were individually weighed and the results stored in an experiment file. A file of the tare weights was also created.

The robotic weighing apparatus was assembled and integrated to a Symyx Renaissance-based workflow. The instrument was designed to weigh DSC sample pans to a resolution of 5 decimal places (0.01 mg), and an accuracy of 0.02 mg. The pans were removed and transferred to another robot (Example 1e) where they were filled with polymer samples and heat-treated.

The workstation used a Tecan2 Freedom EV075® robot and EVOware version 1.2.0 software (current build 1.4.40.0). The Robot was equipped with one arm containing two liquid handling arms. One of the tips was fitted with a pneumatically-operated gripper to pick up small aluminum pans. The other arm was unused. Other hardware added to the system included a Mettler SAG 285 five-place balance, an AlphaStep® stepper motor, a PHD® Rotary Activator and a number of custom-made peripherals.

### Three-Finger Sample Gripper

The sample gripper was designed and manufactured by Automation by Design (ABD) in Beaverton, Mich. The three fingers were designed to deftly pick up the small aluminum sample pans without crushing them. The air supply to the grippers was regulated by a regulator containing two needle valves, one to throttle the rate at which the air enters the gripper assembly, and one that throttles the rate at which air leaves the gripper assembly. The regulator can be adjusted to ensure that sufficient air pressure will be available to open or close the grippers.

### Sample Trays & Tray Holder

The sample trays (i.e., first supports) are shown in FIG. 5. The “mouse ear” cut-outs accommodate the fingers of the three-finger gripper and a container for the samples (e.g., a DSC pan). There are 54 sample positions on each tray to accommodate a typical library size of 48, and allow one column of positions for up to 6 standards. The stand to hold the weighing pan sample trays is shown in FIG. 8. Four sample trays can be held on the stand with four rotating clips which hold the trays to the rack.

### Example 1e

### Deposit-Anneal Unit

The polymer solutions from the synthesis and the standards solutions were placed on the deposit-anneal unit-op deck. The titer-plate of tared DSC pans was also placed on the deck. A protocol was started that controls both the deposition and annealing processes. Parameters for the deposition of the standard(s) were programmed. Process conditions were entered, along with the LibID of the synthesis, the barcode of the titer-plate with empty pans, and a minimum synthesis sample weight. The operator has the option to manually select/deselect wells for processing at this point. Deposition occurs, and upon completion, the operator again has the opportunity to manually reject sample wells. Annealing then proceeds, with the data stored in a new file.

The robotic system for depositions was a Tecan Mini-Prep 75 which was equipped with a dual arm robot. One arm has a heated syringe needle for liquid transfer and the other arm was equipped with a gripper for removing stoppers from the sample tubes. The syringe needle was heated so that cooling and/or precipitation was avoided as the sample was transferred. The deck has two heated zones; one was sized to hold a PPR block with 48 sample tubes and the other to hold the sample holder. The two zones were controlled by separate heaters. The sample block and syringe needle were heated for all solutions while the wafer heater was adjusted according to the sample treatment of the material being studied. The wafer heater can also be programmed to ramp up and down in temperature as necessary for the desired sample preparation. The sample holder was enclosed in a Plexiglas® box with a removable lid and was equipped with a nitrogen purge via a circular tube around the sample holder plate with small holes every 1 mm. The inert atmosphere during the solvent evaporation process reduces the potential for oxidation. The samples could be annealed at the same temperature as deposition, or a higher or lower temperature, as desired. The samples were then cooled.

Alternatively, the sample holder was a single unit made of aluminum (ABD) and has plumbed nitrogen sources around the perimeter of the sides, comprising a box with a lid that has a Plexiglas® window framed in aluminum with a handle. The lid fits snugly against the top of the box. The bottom of the box was a built-in heater platform.

### Example 1f

### Final ‘Weighing’

The cooled titer-plate(s) of Samples are placed on the weigh robot unit-op deck. Up to four plates (LibID's) can be accommodated (see, for example, FIG. 3). An empty DSC rotary holder (FIG. 4), which can accommodate 50 samples was also placed on the deck. The weigh robot software was started to begin the final weigh operation. The barcode of the titer-plate(s) was scanned and the existing file for the associated LibID was retrieved. The barcode on the rotary holder was scanned. The operator may also indicate which sample pans should be transferred to the DSC rotary holder. The gross weights of the sample pans were measured. The net weights were calculated by subtracting the tare from the gross weights. Both gross and net weights were recorded as a final weigh file. Prior to the move of the pans to the DSC rotary holder, the operator has a final opportunity to reject/include samples. Selected samples were moved to the rotary holder and the position of the rotary holder was recorded in association to the sample. This data was written to the associated rotary holder file. The sample pans were “close packed” in the rotary holder to allow multiple Libraries containing a smaller quantity of samples, on a single rotary holder (if possible).

### Example 1g

### DSC Sequence Setup and Runs

The Operator transfers the rotary holder to an available Q-100 DSC Instrument. Run #1 of the sequence (1,2,3, . . . 48) was manually setup and a helper application automatically setup the remaining runs in the sequence, eliminating considerable operator effort and minimizing transcription errors. The instrument barcode of the Q-100 containing the rotary holder and the barcode on the rotary holder itself were scanned. Armed with this information the helper app retrieved the unique rotary holder file for these sample pans from a predesignated location. It then used the manually-entered run #1 as a template, and created all the other runs in the sequence, correctly assigning samples to rotary holder positions, output file names, etc. Upon completion, the operator manually entered the run setup for any standards included on the rotary holder.

Sample scan rates were generally either 10° C./min or 20° C./min but may be as high as 50° C./min or as low as 5° C./min. Temperature ranges for the samples for polyethylene material were −30° C. to 200° C. Other materials can use other temperature ranges.

### Example 1h

### DSC Calculations (Optional) and File Processor Configuration

DSC Calculations

The file processor was configured, including the optional, specific Matlab® calculation(s) to be stored in the database. Typical experiment-specific calculations might include specific DSC peak areas, positions, and ratios. These optional calculations are turned on/off at the file processor. A macro runs upon completion of each run, creating a file containing complete DSC data for that run. That file is automatically “dropped” (stored) in a pre-designated local folder, along with the raw data instrument file. For every well in the library, the physical output of the DSC instrument is a “raw” data file and ASCII data file that are both automatically written to the file processor “dropbox” directory. The ASCII data file (a specific file format) is necessary for Matlab® calculations.

File Processor

The file processor automatically maps the DSC data and the optional Matlab® calculations onto a database. The normal operation of the file processor is to create the well records (i.e. elements or positions) in the database and populate them with data. However, it is possible to run the Matlab® calculations “after the fact,” by properly configuring the file processor.

### Example 2

### High-Throughput Analysis of LLDPE

Samples of LLDPE (Linear Low Density Polyethylene) were prepared according to Example 1, unless otherwise indicated. LLDPE (Linear Low Density Polyethylene) was dissolved at elevated temperature (about 140° C.) in trichlorobenzene to yield a polymer solution that was transferred from a heated shaker to a heated block on the annealing robot. A heated cannula transferred less than 45 μL of polymer solution to pre-tared DSC pans. The set of samples was heated without stirring or shaking at a temperature up to 160° C. for up to 1 hour evaporate the solvent. The heaters were nitrogen purged to prevent degradation. The samples were stepwise cooled by dropping the temperature to 120° C. for 15 minutes then to 60° C. When samples were cool to the touch they were removed for final weighing. The deposition volume and thermal history was stored in a database for each library ID being prepared. A tray of pre-tared pans plus sample was put on the robotic weigher for final weighing. The pans were weighed and then transferred to the DSC carousel. Position, sample name, and sample mass were recorded for each. The sample carousel holder was manually transferred to the DSC. An initial sample was programmed into the DSC identifying the method, file location, and any post-processing information. The text files generated by the DSC process were saved for offline data analysis. A program to transfer the information generated on the robotic weigher was executed and the DSC program was populated with all samples with sample method as the first entry. When sample analysis was complete, data goes to a dropbox where a file loader processed the data and sent it to a SYMYX® database (Oracle-based) and runs a custom MatLab-based analysis For these samples the baseline was drawn from 25° C. to 150° C. with a perpendicular drop at 115° C. The program compared the peak area on both sides of the dropping point and ratios them for a % high density (higher temperature) and % low density portions (low temperature). This was compared to Dowlex 2045G, a standard material, and/or the library generated standard to determine success.

### Example 3

### Reproducibility Studies

The material used for these studies is a commercial material, Dowlex 2045G. All samples were prepared according to Example 1, unless otherwise indicated. Samples were prepared by solution deposition and evaporation of trichlorobenzene (solvent) from the polymer. TA Instruments hermetic (deep well) pans without lids were used for this work. The DSC data are scaled by sample mass, and baseline corrected at 25 and 150° C.

### Example 3a

### Run #1

The data were collected using the 2910 TA Instruments DSC. The samples were prepared and subsequently annealed on the deposition/annealing robot at a set point of 140° C. for 1 hour. The actual temperature of the samples was approximately 130° C. The cooling protocol was to shut off heat to cool to room temperature which took at least 1.5 hours. The melting points of the largest peaks varied from 122 to 129° C. The ratio was calculated as the heat from 25 to 119.5° C. divided by the heat from 25 to 150° C. and varied from 0.73 to 0.78.

### Example 3b

### Run #2

The data were collected using the 2910 TA Instruments DSC. The samples were prepared and subsequently annealed on the deposition/annealing robot at a set point of 160° C. for one hour. The actual temperature of the samples was approximately 145° C. The cooling protocol was to shut off heat to cool to room temperature which took at least 1.5 hours under a flow of nitrogen. Only 38 scans were available because of equipment failure. Most of the scans lie close to each other with a melting temperature ranging from 123.5 to 124.5° C. The ratio was calculated as the heat from 25 to 119.5° C. divided by the heat from 25 to 150° C. and generally varied from 0.70 to 0.75.

### Example 3c

### Run #3

The data were collected using a Q100 TA Instruments DSC. The annealing protocol was the same as conducted in Example 3b. Two DSC's were off scale due to very low and inaccurate masses (B2 and B4). These two scans were not included in further analysis. The peak melting points for the rest of the samples ranges from 121.25 to 123.25° C. The ratio was calculated as the heat from 25 to 118° C. divided by the heat from 25 to 150° C. and varied from 0.54 to 0.73, with an average of 0.71. The breakpoint of 118 was changed from the Examples 3a and 3b breakpoint of 119.5 because of the DSC used for this study.

### Example 3d

### Run #4

The data were collected using a Q100 TA Instruments DSC. The samples were prepared and subsequently annealed on the deposition/annealing robot at a set point of 160° C. for 30 minutes. The actual temperature of the samples was approximately 145° C. For this study, the cooling procedure was changed to a stepwise approach. After the 30 minute anneal, the set point was changed to 140° C. Once 140° C. was achieved it was held for 30 minutes. Then the set point was then changed to 120° C. Once this temperature was achieved, it was again held for 30 minutes. Then the set point was changed to 80° C. Once this temperature was achieved, it was again held for 30 minutes. Finally the heat was turned off and it was cooled to room temperature under a flow of nitrogen. There were two peaks present, one at approximately 110° C., and the other which varied from 123 to 124° C. There was one unusual sample, H1. This sample did not have an extreme sample mass; the sample masses for the whole set of 47 samples varied from 1.22 to 1.82 mg. Even though it was not investigated further why this measurement was unusual, the results from the H1 sample were not considered further. The calculated ratios used a breakpoint of 118° C. and varied from 0.62 to 0.71.

### Example 4

### Manual Versus Automated Sample Analysis

Two libraries were examined in this development work, 103414 and 103422. The manual analysis was completed on these libraries. The manual approach involved using the TA software to identify the baseline correction regions, and areas between various temperatures. This process took approximately 4-6 hours per library. The results from the automated method were compared to the results of the manual analysis. The automated approach takes only seconds to complete per library. It was thought that the ratio of the lower density fraction relative to the total area would be informative for the specific study. A ratio=1.0 is interpreted as there is only lower density material (i.e., no HD peak).

The comparison between the automated and manually calculated ratios for library 103414 is shown in Table 2. The samples are ordered from high to low ratio. The manual and automated approaches match well. The comparison between the automated and manual ratios for library 103422 is shown in Table 3. The samples are ordered from high to low ratio. The manual and automated approaches match well. There were two samples for which the difference can be considered large, C2 and E4. This arises from a difference in where the separation between the low and high density fractions was selected. The manual approach made the split between the low and high density material at approximately 120° C., while the automated approach made the split at 126.5° C. Either choice can realistically be made. This variation makes manual interpretation of DSC data somewhat variable. With the software protocol a consistent rule was applied.

TABLE 2
(M = manual; A = automated)

| | | | | | | 1st | | |
|---|---|---|---|---|---|---|---|---|
| | | | | | | Peak | Max peak, | HD peak, |
| | Tₘ₁, | Tₘ₂, | Ratio, | Ratio, | Delta | end ° C. | ° C. | ° C., |
| Cell | [M] | [M] | [M] | [A] | (A − M) | [A] | [A] | [A] |
| C3 | 125.54 | 128.75 | 0.92 | 0.92 | 0.00 | 126.75 | 123.50 | 128.50 |
| C2 | 123.98 | 127.7 | 0.82 | 0.81 | 0.01 | 126.00 | 124.00 | 127.75 |
| A2 | 123.48 | 129.28 | 0.76 | 0.76 | 0.00 | 126.25 | 129.25 | 129.25 |
| A5 | 120.92 | 128.27 | 0.71 | 0.70 | 0.01 | 125.75 | 128.25 | 128.25 |
| A3 | 120.03 | 127.57 | 0.62 | 0.69 | −0.07 | 125.25 | 127.50 | 127.50 |
| H4 | 121.98 | 128.76 | 0.61 | 0.66 | −0.06 | 126.00 | 128.75 | 128.75 |
| A6 | 120.97 | 128.92 | 0.61 | 0.61 | 0.00 | 125.25 | 129.00 | 129.00 |
| G2 | 122.19 | 129.34 | 0.57 | 0.57 | 0.01 | 125.50 | 129.25 | 129.25 |
| D4 | 119.87 | 127.19 | 0.62 | 0.57 | 0.06 | 124.75 | 127.25 | 127.25 |
| F3 | 123.65 | 128.89 | 0.56 | 0.54 | 0.02 | 124.75 | 128.75 | 128.75 |
| F5 | 124.7 | 129.93 | 0.55 | 0.54 | 0.01 | 125.50 | 130.00 | 130.00 |
| F1 | 122.96 | 129.39 | 0.51 | 0.51 | 0.01 | 125.50 | 129.50 | 129.50 |
| G1 | 121.43 | 128.09 | 0.50 | 0.50 | 0.00 | 124.50 | 128.00 | 128.00 |
| F6 | 121.72 | 129.76 | 0.50 | 0.50 | 0.00 | 124.75 | 129.75 | 129.75 |
| F2 | 122.6 | 128.68 | 0.50 | 0.49 | 0.01 | 125.25 | 128.75 | 128.75 |
| A4 | 120.62 | 128.89 | 0.48 | 0.48 | 0.00 | 124.75 | 129.00 | 129.00 |
| E2 | 121.01 | 129.15 | 0.48 | 0.48 | 0.00 | 124.50 | 129.25 | 129.25 |
| G4 | 119.23 | 127.85 | 0.47 | 0.46 | 0.01 | 122.50 | 127.75 | 127.75 |
| G3 | 122.88 | 129.38 | 0.58 | 0.46 | 0.12 | 125.75 | 129.50 | 129.50 |
| G5 | 120.79 | 130.29 | 0.38 | 0.37 | 0.01 | 124.00 | 130.25 | 130.25 |
| D2 | 122.91 | 131.41 | 0.34 | 0.3 | 0.00 | 125.00 | 131.50 | 131.50 |

TABLE 3
(M = manual; A = automated)

| | | | | | | 1st Peak | Max | HD peak, |
|---|---|---|---|---|---|---|---|---|
| | Tₘ₁, | Tₘ₂, | Ratio, | Ratio, | Delta | end ° C. | peak, ° C. | ° C., |
| Cell | [M] | [M] | [M] | [A] | (A − M) | [A] | [A] | [A] |
| A4 | 119.16 | 130.08 | 0.58 | 0.59 | 0.01 | 130.00 | 123.75 | 130.00 |
| E4 | 116.28 | 129.03 | 0.38 | 0.49 | 0.12 | 129.00 | 126.50 | 129.00 |
| B5 | 116.54 | 129.18 | 0.50 | 0.49 | −0.01 | 129.25 | 121.50 | 129.25 |
| A3 | 119.11 | 130.48 | 0.50 | 0.47 | −0.03 | 130.50 | 123.75 | 130.50 |
| C2 | 115.87 | 129.03 | 0.32 | 0.44 | 0.12 | 129.00 | 126.25 | 129.00 |
| A5 | 118.22 | 129.7 | 0.49 | 0.43 | −0.06 | 129.75 | 122.75 | 129.75 |
| B2 | 118.72 | 130.36 | 0.44 | 0.43 | −0.01 | 130.25 | 123.25 | 130.25 |
| A2 | 116.19 | 129.29 | 0.47 | 0.43 | −0.04 | 129.25 | 121.50 | 129.25 |
| C5 | 117.09 | 129.55 | 0.41 | 0.42 | 0.00 | 129.50 | 121.75 | 129.50 |
| B3 | 117.01 | 129.47 | 0.42 | 0.41 | −0.01 | 129.50 | 121.75 | 129.50 |
| H1 | 117.14 | 128.62 | 0.43 | 0.40 | −0.03 | 128.75 | 121.25 | 128.75 |
| B1 | 117.42 | 129.6 | 0.40 | 0.39 | −0.01 | 129.50 | 122.25 | 129.50 |
| D1 | 116.01 | 129.04 | 0.38 | 0.39 | 0.02 | 129.00 | 120.75 | 129.00 |
| G1 | 116.93 | 129.29 | 0.38 | 0.39 | 0.01 | 129.25 | 121.00 | 129.25 |
| A6 | 117.91 | 129.98 | 0.39 | 0.39 | −0.01 | 130.00 | 122.25 | 130.00 |
| B4 | 117.26 | 129.65 | 0.40 | 0.39 | −0.02 | 129.75 | 122.00 | 129.75 |
| C3 | 116.85 | 129.43 | 0.34 | 0.37 | 0.03 | 129.50 | 122.00 | 129.50 |
| E5 | 117.58 | 129.74 | 0.38 | 0.37 | −0.01 | 129.75 | 121.75 | 129.75 |
| E3 | 116.88 | 129.12 | 0.36 | 0.37 | 0.01 | 129.25 | 120.50 | 129.25 |
| G3 | 115.46 | 128.94 | 0.35 | 0.37 | 0.01 | 129.00 | 120.75 | 129.00 |
| H5 | 116.58 | 129.45 | 0.41 | 0.37 | −0.05 | 129.50 | 121.25 | 129.50 |
| F6 | 115.58 | 128.64 | 0.31 | 0.36 | 0.05 | 128.50 | 118.25 | 128.50 |
| F4 | 117.52 | 129.58 | 0.35 | 0.36 | 0.01 | 129.75 | 122.00 | 129.75 |
| F5 | 117.1 | 130.48 | 0.36 | 0.36 | 0.00 | 130.50 | 121.25 | 130.50 |
| D5 | 114.35 | 126.9 | 0.35 | 0.35 | 0.01 | 126.75 | 119.25 | 126.75 |
| G6 | 112.66 | 128 | 0.33 | 0.35 | 0.01 | 128.00 | 118.25 | 128.00 |
| C4 | 117.46 | 129.64 | 0.31 | 0.33 | 0.01 | 129.75 | 121.75 | 129.75 |
| C6 | 114.04 | 127.88 | 0.32 | 0.32 | 0.00 | 128.00 | 119.75 | 128.00 |
| G2 | 116.13 | 129.48 | 0.32 | 0.32 | 0.00 | 129.50 | 120.75 | 129.50 |
| H4 | 115.88 | 130.16 | 0.29 | 0.31 | 0.02 | 130.00 | 120.50 | 130.00 |
| E2 | 117.94 | 129.16 | 0.34 | 0.30 | −0.04 | 129.25 | 121.00 | 129.25 |
| F1 | 115.6 | 129.39 | 0.31 | 0.30 | −0.01 | 129.25 | 120.25 | 129.25 |
| D4 | 116.08 | 129.41 | 0.30 | 0.28 | −0.03 | 129.50 | 120.75 | 129.50 |
| E1 | 118.69 | 129.53 | 0.21 | 0.26 | 0.05 | 129.50 | 121.75 | 129.50 |
| G5 | 118.76 | 129.6 | 0.20 | 0.20 | 0.00 | 129.50 | 118.25 | 129.50 |
| E6 | 115.96 | 128.7 | 0.23 | 0.20 | −0.03 | 128.75 | 119.75 | 128.75 |

### Example 5

### HT-DSC for HT-CRYSTAF-Like Analysis of Standard Ethylene/1-Octene [EO] Copolymers

A deposition, annealing, and DSC process similar to CRYSTAF was developed using four EO resins listed in Table 4. Two of these resins, Dowlex 2045G and Dowlex NG 5056E are commercial samples and the other two are pilot plant resins (PP-1 & PP-2). The polymers were chosen for the study because the CRYSTAF results were already available and they covered the typical range for these types of polymers.

TABLE 4

| | | | | % HD from |
|---|---|---|---|---|
| Standard | Melt Index | Density | I₁₀/I₂ | CRYSTAF |
| Dowlex 2045G | 1.00 | 0.9200 | 8.0 | 27.5 |
| Dowlex NG5056E | 1.05 | 0.9190 | 7.8 | 18.6 |
| PP-1 | 1.09 | 0.9215 | 8.3 | 27.2 |
| PP-2 | 0.85 | 0.9190 | 8.8 | 16.1 |

Sample deposition, annealing, and analysis were performed as described in Example 1 under an inert atmosphere (nitrogen) unless otherwise indicated below. The sample well and syringe needle were heated at 160° C. (measured temperature and set point) for all solutions while the wafer heater was adjusted according to the sample treatment of the material being studied. A heated 30 mg/mL solution of polymer dissolved in 1,2,4-trichlorobenzene (TCB) was robotically deposited into heated DSC pans.

During solvent evaporation, the samples undergo a defined thermal history. Several annealing conditions were evaluated in an attempt to maximize the fractionation of the EO polymers as listed in Table 5. The temperatures listed in the table refer to the controller set point, but the actual temperature of the sample was approximately 10° C. lower than the set-point.

TABLE 5

| | | | | Cool Step 1 | Cool Step 2 | Cool Step 3 | Cool Step 4 | Cool Step 5 |
|---|---|---|---|---|---|---|---|---|
| | | | Time at | Set point | Set point | Set point | Set point | Set point |
| | | Wafer | wafer | Temp (° C.)/ | Temp (° C.)/ | Temp (° C.)/ | Temp (° C.)/ | Temp (° C.)/ |
| | PPR | temp @ | deposition | Hold | Hold | Hold | Hold | Hold |
| | block/needle | deposition | temp | Time | Time | Time | Time | Time |
| No. | Temp (° C.) | (° C.) | (min) | (min) | (min) | (min) | (min) | (min) |
| 1 | 160 | 130 | 60 | 25/60* | | | | |
| 2 | 160 | 140 | 60 | 25/60* | | | | |
| 3 | 160 | 160 | 60 | 25/60* | | | | |
| 4 | 160 | 160 | 60 | 25/90* | | | | |
| 5 | 160 | 160 | 15 | 123/5 | 110/15 | 80/15 | 25/0 | |
| 6 | 160 | 160 | 15 | 129/15 | 120/15 | 110/15 | 80/15 | 25/0 |
| 7 | 160 | 160 | 15 | 135/15 | 120/5 | 110/5 | 80/5 | 25/0 |
| 8 | 160 | 170 | 15 | 140/5 | 135/5 | 130/15 | 120/15 | 110/5 |
| | | | | | | | | 90/5 |
| | | | | | | | | 70/5 |
| | | | | | | | | RT/0 |
| 9 | 160 | 170 | 5 | 130/15 | 110/15 | 70/15 | 25/0 | |
| 10 | 160 | 150 | 0 | 140/15 | 120/15 | 60/0 | | |

*Time required to cool room temperature

The TA Instruments 2910 DSC with auto sampler and mechanical cooling was used for the study. Sample pans were manually transferred from the sample holder after deposition and annealing to the DSC auto sampler tray. Sample scan rates were generally either 10° C./min or 20° C./min and the temperature range used for the analysis was −30° C. to 200° C. DSC pans were manually weighed before and after deposition and the weights were manually entered into the TA software.

Method 10 listed in Table 2 describes the sample preparation conditions that minimized analysis time while maximizing peak resolutions (required less than 4 hours to complete). These conditions were tested on a set of 48 Dowlex 2045G samples and the data is reported in Table 6.

TABLE 6

| | Temperature | | Sample | | |
|---|---|---|---|---|---|
| | of largest | Area, | mass, | % High | |
| Cell | peak, ° C. | J/g | mg | Density | % Low Density |
| A1 | 123.0 | 141.2 | 1.55 | 29.9 | 70.1 |
| A2 | 122.8 | 149.6 | 1.53 | 29.4 | 70.6 |
| A3 | 122.8 | 156.0 | 1.55 | 28.9 | 71.1 |
| A4 | 123.5 | 131.4 | 1.56 | 31.1 | 68.9 |
| A5 | 123.3 | 137.8 | 1.59 | 30.6 | 69.4 |
| A6 | 123.8 | 132.5 | 1.61 | 31.3 | 68.7 |
| B1 | 123.5 | 137.7 | 1.51 | 31.3 | 68.7 |
| B2 | 123.5 | 147.8 | 1.44 | 31.0 | 69.0 |
| B3 | 123.5 | 147.4 | 1.58 | 30.2 | 69.8 |
| B4 | 123.5 | 139.2 | 1.62 | 30.9 | 69.1 |
| B5 | 123.8 | 139.9 | 1.60 | 31.2 | 68.8 |
| B6 | 123.8 | 136.0 | 1.45 | 31.0 | 69.0 |
| C1 | 123.5 | 135.0 | 1.39 | 31.7 | 68.3 |
| C2 | 123.0 | 144.2 | 1.40 | 30.3 | 69.7 |
| C3 | 123.3 | 140.8 | 1.47 | 30.6 | 69.4 |
| C4 | 123.5 | 140.7 | 1.63 | 30.7 | 69.3 |
| C5 | 123.3 | 138.2 | 1.59 | 30.7 | 69.3 |
| C6 | 123.3 | 139.3 | 1.48 | 30.3 | 69.7 |
| D1 | 123.3 | 130.0 | 1.48 | 32.0 | 68.0 |
| D2 | 123.3 | 139.8 | 1.44 | 30.7 | 69.3 |
| D3 | 123.5 | 136.8 | 1.67 | 31.7 | 68.3 |
| D4 | 123.5 | 143.5 | 1.67 | 30.4 | 69.6 |
| D5 | 123.5 | 139.5 | 1.64 | 30.6 | 69.4 |
| D6 | 123.5 | 136.6 | 1.39 | 32.1 | 67.9 |
| E1 | 123.0 | 133.0 | 1.34 | 30.5 | 69.5 |
| E2 | 123.0 | 133.0 | 1.34 | 30.6 | 69.4 |
| E3 | 123.3 | 130.2 | 1.25 | 31.1 | 68.9 |
| E4 | 123.8 | 104.2 | 1.33 | 32.0 | 68.0 |
| E5 | 123.5 | 123.2 | 1.42 | 30.4 | 69.6 |
| E6 | 123.5 | 147.9 | 1.20 | 31.2 | 68.8 |
| F1 | 123.3 | 139.7 | 1.23 | 31.7 | 68.3 |
| F2 | 123.5 | 130.6 | 1.28 | 31.6 | 68.4 |
| F3 | 123.3 | 139.8 | 1.25 | 31.3 | 68.7 |
| F4 | 123.5 | 139.4 | 1.29 | 31.1 | 68.9 |
| F5 | 123.5 | 139.6 | 1.32 | 30.5 | 69.5 |
| F6 | 123.5 | 139.2 | 1.28 | 30.9 | 69.1 |
| G1 | 123.3 | 129.5 | 1.28 | 31.6 | 68.4 |
| G2 | 123.5 | 110.7 | 1.38 | 32.6 | 67.4 |
| G3 | 123.3 | 144.6 | 1.28 | 30.9 | 69.1 |
| G4 | 123.5 | 140.6 | 1.28 | 30.7 | 69.3 |
| G5 | 123.5 | 133.1 | 1.33 | 30.7 | 69.3 |
| G6 | 123.5 | 136.3 | 1.32 | 30.4 | 69.6 |
| H1 | 123.3 | 138.8 | 1.34 | 30.7 | 69.3 |
| H2 | 123.5 | 134.2 | 1.32 | 31.4 | 68.6 |
| H3 | 123.5 | 126.3 | 1.27 | 29.7 | 70.3 |
| H4 | 123.5 | 136.4 | 1.28 | 30.7 | 69.3 |
| H5 | 123.5 | 139.6 | 1.29 | 30.3 | 69.7 |
| H6 | 123.5 | 126.6 | 1.30 | 31.7 | 68.3 |
| Avg | 123.4 | 136.6 | 1.4 | 30.9 | 69.1 |
| std dev | 0.23 | 8.79 | 0.14 | 0.71 | 0.71 |

The standards of Table 4 were put through the Method 10 sample preparation and compared to CRYSTAF results previously obtained (Table 7). When comparing the % HD from the HT-DSC method to the % HD from CRYSTAF, the same trend was observed although the absolute values were different. The last column in the table compares a manual integration by picking a unique point based on the peak separation, versus the automated MatLab® integration at 118° C. MatLab® uses 118° C. because it was considered to be the point at which a difference between low and high density material would be discernable. The data represented in the table shows that both methods compare very well.

TABLE 7

| | | | % HD from |
|---|---|---|---|
| | % HD from | % HD | manual |
| Standard | MatLab ® | from CRYSTAF | integration |
| Dowlex2045G | 28.5 | 27.5 | 25 |
| Dowlex NG5056E | 25 | 18.6 | 25 |
| PP-1 | 32 | 27.2 | 31 |
| PP-2 | 21 | 16.1 | 19.5 |

The data for these samples indicated that there was approximately 6% of the sample that remained soluble in the solvent and did not crystallize even at room temperature. If we assume this means that the DSC experiments has analyzed all of the polymer, approximately 6% more than the same material in a CRYSTAF type experiment, we can fit a line to the few data points we have and force the intercept to be 6%. The correlation here is reasonable and the slope indicates a nearly 1:1 correlation for the two methods once the soluble fraction of the CRYSTAF method is accounted for. The data analysis was done using MatLab® software which calculates the melt temperatures, heats of fusion, and percentages of the high density fraction in the polymer samples.

The advantage for using the HT-DSC to generate “CRYSTAF like” data allows one to rapidly prescreen samples to determine those you might want to follow up on with CRYSTAF measurements. Since CRYSTAF is a slow measurement, only a few runs/day, the HT-DSC gives a comparable screen even though it is not actually a CRYSTAF method.

The present invention is illustrated by way of the foregoing description and examples. The foregoing description is intended as a non-limiting illustration, since many variations will become apparent to those skilled in the art in view thereof. It is intended that all such variations within the scope and spirit of the appended claims be embraced thereby.

Changes can be made in the composition, operation and arrangement of the method of the present invention described herein without departing from the concept and scope of the invention as defined in the following claims.

We claim:

1. A system comprising:
a first support;
a sample deposition system configured to automatically deposit samples into individual containers arranged on the first support in a first predetermined arrangement;
a balance for weighing the containers;
a second support for holding the containers in a second predetermined arrangement, wherein the second support is operable in a sample analysis system for analyzing the samples in the containers; and
a transfer system configured to individually transfer the containers among the first support, the second support, and the balance so as to maintain the first predetermined arrangement on the first support and the second predetermined arrangement on the second support.

2. The system of claim 1, further comprising a heater arranged to heat the first support.

3. The system of claim 1, wherein the sample deposition system comprises a heater for heating the samples.

4. The system of claim 1, further comprising means for maintaining an inert atmosphere over the samples in the containers arranged on the first support.

5. The system of claim 1, wherein the sample deposition system is an automatic pipetter.

6. The system of claim 1, wherein the transfer system is a robot comprising a movable gripper for gripping individual containers.

7. The system of claim 1, wherein the sample analysis system is a differential scanning calorimeter.

8. The system of claim 1, wherein the containers hold a volume of about 10 microliters (μL) to about 100 μL.

9. The system of claim 8, wherein the containers are aluminum pans.

10. A system comprising:
a first support;
a plurality of containers arranged on the first support in a first predetermined arrangement;
a balance for individually weighing the containers; and
a robot comprising a movable gripper, wherein the robot is configured to use the movable gripper to individually transfer the containers between the first support and the balance so as to maintain the first predetermined arrangement.

11. The system of claim 10, wherein the robot further comprises a movable cannula, and wherein the robot is configured to use the movable cannula to deposit samples into individual containers.

12. The system of claim 10, wherein the robot further comprises a movable vacuum aspirator, and wherein the robot is configured to use the movable vacuum aspirator to individually place lids on the containers to provide container-lid assemblies.

13. The system of claim 12, further comprising a sealing system for sealing the container-lid assemblies to provide sealed containers, wherein the robot is configured to use the movable gripper to move the container-lid assemblies to the sealing system and to remove the sealed containers from the sealing system.

14. The system of claim 13, further comprising a second support, wherein the robot is configured to use the movable gripper to place the sealed containers on the second support in a second predetermined arrangement.

15. A method for analyzing multiple samples, comprising the steps of:
arranging a plurality of containers on a first support in a first predetermined arrangement;
automatically transferring individual containers from the first support to a balance and back again so as to maintain the first predetermined arrangement;
measuring the mass of each container placed on the balance;
using an automated sample deposition system to deposit samples into individual containers on the first support so as to provide sample-containing containers;
using an automated transfer system to transfer individual sample-containing containers from the first support to the balance and back again so as to maintain the first predetermined arrangement;
measuring the mass of each sample-containing container placed on the balance;
using the automated transfer system to transfer sample-containing containers to a second support;
placing the second support with the sample-containing containers thereon in a sample analysis system; and
using the sample analysis system to measure at least one physical property of each sample on the second support.

16. The method of claim 15, further comprising the step of heating the sample-containing containers.

17. The method of claim 15, further comprising the step of individually capping and sealing each sample-containing container.

18. The method of claim 15, further comprising the steps of:
selecting sample-containing containers for transfer to the second support;
transferring each selected sample-containing container to a respective position on the second support; and
recording the position of each sample-containing container on the second support.

19. The method of claim 15, wherein the sample analysis system is a differential scanning calorimeter.

20. The method of claim 19, wherein the physical property is melting point, phase transition enthalpy, heat capacity, reaction enthalpy, or composition.
